(19) United States
(12) Patent Application Publication
(10) Pub. No.: US 2025/0291205 A1
(43) Pub. Date: Sep. 18, 2025

(54) OPTICAL LENS INTENDED TO BE WORN BY A WEARER

(71) Applicant: Essilor International, Charenton-Le-Pont (FR)

(72) Inventors: Patrick HUGONNEAUX, Charenton-Le-Pont (FR); Matthieu GUILLOT, Charenton-Le-Pont (FR); Eric GACOIN, Charenton-Le-Pont (FR); Bruno FERMIGIER, Charenton-Le-Pont (FR)

(73) Assignee: Essilor International, Charenton-Le-Pont (FR)

(21) Appl. No.: 18/862,337

(22) PCT Filed: Apr. 26, 2023
(86) PCT No.: PCT/EP2023/061054

§ 371 Date: Nov. 1, 2024

(30) Foreign Application Priority Data
May 3, 2022 (EP) 22305662.3

(51) Int. Cl. G02C 7/08

(52) U.S. Cl. CPC G02C 7/086; G02C 2202/16; G02C 2202/24

(57) ABSTRACT

Optical lens intended to be worn by a wearer An optical lens intended to be worn by a wearer comprising: —a refraction area having a refractive power based on a prescription for said eye of the wearer; —a plurality of optical elements having a transparent optical function of not focusing an image on the retina of the eye of the wearer when the optical lens is worn in standard wearing conditions, —a zone of interest comprising a subset of the optical elements, each optical elements in the subset bearing a cylinder component on its surface, wherein the zone of interest is of at least 50 mm2, and the standard deviation of the orientations of the cylinder axis of each optical element comprised in the zone of interest is smaller than or equal to 15° with respect to a common predefined direction.

### TECHNICAL FIELD

The disclosure relates to an optical lens intended to be worn by a wearer comprising a refraction area having a refractive power based on a prescription for said eye of the wearer and a plurality of optical elements having a transparent optical function of not focusing an image on the retina of the eye of the wearer when the optical lens is worn in standard wearing conditions.

### BACKGROUND OF THE DISCLOSURE

Myopia of an eye is characterized by the fact that the eye focuses distant objects in front of its retina. Myopia is usually corrected using a concave lens and hyperopia is usually corrected using a convex lens.

Myopia, also referred as to short-sightedness, has become a major public health problem worldwide. Accordingly, a large effort has been made to develop solutions aiming to slow down myopia progression.

Most of the recent management strategies for myopia progression involved acting on the peripheral vision using optical defocus. This approach has received a great deal of interest since works in chicks and primates showed that foveal refractive error could be manipulated through peripheral optical defocus without the involvement of an intact fovea. Several methods and products are used to slow down myopia progression by inducing such peripheral optical defocus. Among these solutions, orthokeratology contact lenses, soft bifocal and progressive contact lenses, circular progressive ophthalmic lenses, and lenses with array of lenslets have been shown to be more or less effective, through randomized controlled trials.

Myopia control solutions with array of lenslets have been proposed, in particular by the applicant. The purpose of this array of lenslets is to provide an optical blurred image, in front of the retina, triggering a stop signal to the eyes growth, while enabling a good vision.

Although most of the prior art studies have focused on the influence of the size, density or optical power of the lenslets, the inventors have observed that the lenslets may have a cylinder and that such cylinder has an impact on the quality of the vision of the wearer and/or the improve the myopia slow down function.

Therefore, there is a need to provide optical lenses comprising optical elements having an transparent optical function of not focusing an image on the retina of the wearer where the cylinder of the optical elements is controlled.

### SUMMARY OF THE DISCLOSURE

To this end, the disclosure proposes an optical lens intended to be worn by a wearer, for example in front of an eye of the wearer, comprising:
a refraction area having a refractive power based on a prescription for said eye of the wearer;
a plurality of optical elements having a transparent optical function of not focusing an image on the retina of the eye of the wearer when the optical lens is worn in standard wearing conditions,
a zone of interest comprising a subset of the optical elements, each optical element in the subset bearing a cylinder component on its surface,
wherein the zone of interest is of at least 50 mm², for example at least 75 mm², and the standard deviation of the orientations of the cylinder axis of each optical element comprised in the zone of interest is smaller than or equal to 15° with respect to a common predefined direction, for example smaller than or equal to 10° with respect to a common predefined direction.

Advantageously, having a controlled cylinder orientation is an advantage for the wearer, in particular it improves the quality of the vision and/or the myopia slow, down function of the optical elements.

Indeed, controlling the cylinder orientation enables to compensate for the astigmatism created by the lenslets in peripheral vision. Therefore, the optical lens according to the disclosure has an improved quality of punctual defocus, in particular the quality of the spot of light created by the lenslets in front of the retina.

According to further embodiments which can be considered alone or in combination:
the zone of interest comprises at least 10 optical elements, for example at least 20 optical elements, for example at least 200 optical elements, for example at least 700 optical elements, having a transparent optical function of not focusing an image on the retina of the eye of the wearer when the lens element is worn in standard wearing conditions; and/or
at least 50%, for example at least 80%, for example all of the optical elements have an optical function of focusing an image other than on the retina of the eye of the person when the optical lens is worn in standard wearing conditions, for example when considering an Atchison eye model; and/or
at least 50%, for example at least 80%, for example all of the optical elements have an absolute value of cylinder power greater than or equal to 0.1 D, for example greater than or equal to 0.2 D; and/or at least part of one of the front or back surface of the optical lens comprises at least one layer of at least one coating element covering at least part of the surfaces on which the optical elements are placed; and/or
at least 50%, for example at least 80%, for example all, of the optical elements are located on one of the surface of the optical lens, for example the front surface of the optical lens.
at least 50%, for example at least 80%, for example all, of the optical elements are located between the front and the back surfaces of the optical lens; and/or
at least 50%, for example at least 80%, for example all, of the optical elements are refractive lenslets; and/or
the zone of interest extends radially from the optical center of the optical lens; and/or
at least 50%, for example at least 80%, for example all, of the optical elements are positioned along at least 5 concentric rings and wherein the zone of interest extends radially over at least 5 of the concentric rings; and/or
at least 50%, for example at least 80%, for example all, of the optical elements are positioned on a structured mesh, the structured mesh being a squared mesh or a honeycomb mesh or a triangle mesh or an octagonal mesh; and/or
the zone of optical interest comprises the optical center of the optical lens and is of at least 150 mm², for example of at least 500 mm²; and/or
the zone of optical interest is a circular zone centered on the optical center of the optical lens; and/or
the zone of optical interest is a circular zone centered on the optical center of the optical lens having a radius greater than or equal to 15 mm, for example greater than or equal to 20 mm, for example greater than or equal to 25 mm; and/or
the zone of optical interest is at least 700 mm², for example at least 1250 mm², for example is at least 1900 mm²; and/or
the standard deviation of the orientations of the cylinder axis of the at least 50%, for example at least 90%, for example all, of the optical elements of the optical lens is smaller than or equal to 20° with respect to a common predefined direction, for example smaller than or equal to 15° with respect to a common predefined direction, for example smaller than or equal to 10° with respect to a common predefined direction, for example smaller than or equal to 5° with respect to a common predefined direction, for example smaller than or equal to 2° with respect to a common predefined direction; and/or
at least 20%, for example at least 40%, for example at least 70%, for example all, of the optical elements have a difference of orientation of the cylinder axis with respect to a common predefined direction smaller than or equal to 5°, for example smaller than or equal to 2°; and/or
the optical lens comprises a central zone corresponding to a zone centered on the optical center of the optical lens and does not comprise any optical element; and/or
the optical lens comprises an empty zone centered on the optical center of said lens element and having a diameter greater than to equal to 7 mm, for example greater than or equal to 8 mm and smaller than or equal to 15 mm, for example smaller than or equal to 12 mm, which does not comprise any optical element; and/or
the refractive area is formed as the area other than the areas formed as the plurality of optical elements; and/or
the area of each optical elements is greater than or equal to 0.4 mm² and smaller than or equal to 5 mm², for example smaller than or equal to 4 mm²; and/or
the ratio of the total area of the optical elements with respect to the total area of the surface of the optical lens is greater than or equal 20%, for example greater than or equal to 30% and smaller than or equal to 80%, for example smaller than or equal to 70%; and/or
at least 50%, for example 80%, for example all, of the optical elements are multifocal lenslets; and/or
at least 50%, for example 80%, for example all, of the optical elements are diffractive lenslets; and/or
the diffractive lenses are contiguous diffractive lenslets; and/or
at least 50%, for example at least 80%, for example all, of the optical elements are diffusive lenslets; and/or
at least 50%, for example at least 80%, for example all, of the optical elements are located on the back surface of the lens element; and/or
for every circular zone having a radius comprised between 2 and 4 mm comprising a geometrical center located at a distance of the framing reference that faces the pupil of the user gazing straight ahead in standard wearing conditions greater or equal to said radius+5 mm, the ratio between the sum of areas of the parts of optical elements located inside said circular zone and the area of said circular zone is greater than or equal to 20%, for example greater than or equal to 30%, for example greater than or equal to 40% and smaller than or equal to 80%, for example smaller than or equal to 70%, for example smaller than or equal to 60%; and/or
for every circular zone having a radius comprised between 2 and 4 mm comprising a geometrical center located at a distance of the framing reference that faces the pupil of the user gazing straight ahead in standard wearing conditions equal to said radius+5 mm, the ratio between the sum of areas of the parts of optical elements located inside said circular zone and the area of said circular zone is greater than or equal to 20%, for example greater than or equal to 30%, for example greater than or equal to 40% and smaller than or equal to 80%, for example smaller than or equal to 70%, for example smaller than or equal to 60%; and/or
the lens element further comprises at least four optical elements organized in at least two groups of contiguous optical elements; and/or
each group of contiguous optical element is organized in at least two concentric rings having the same center, the concentric ring of each group of contiguous optical element being defined by an inner diameter corresponding to the smallest circle that is tangent to at least one optical element of said group and an outer diameter corresponding to the largest circle that is tangent to at least one optical elements of said group; and/or
at least part of, for example all the concentric rings of optical elements are centered on the optical center of the surface of the lens element on which said optical elements are disposed; and/or
the concentric rings of optical elements have a diameter greater than or equal to 9.0 mm and smaller than or equal to 60 mm; and/or
the distance between two successive concentric rings of optical elements is greater than or equal to 0.5 mm, for example greater than or equal to 2 mm, the distance between two successive concentric rings being defined by the difference between the outer diameter of a first concentric ring and the inner diameter of a second concentric ring, the second concentric ring being closer to the periphery of the lens element; and/or
at least 60%, for example at least 75%, for example at least 90%, for example all of the optical elements have a radial orientation of the cylinder axis; and/or
at least 60%, for example at least 75%, for example at least 90%, for example all, of the optical elements have a deviation of the orientation of their cylinder axis with the local radial direction with respect to the optical center of the optical lens smaller than or equal to 5°, for example smaller than or equal to 2°; and/or
at least 60%, for example at least 75%, for example at least 90%, for example all of the optical elements have an ortho-radial orientation of the cylinder axis; and/or
at least 0%, for example at least 75%, for example at least 90%, for example all of the optical elements have a deviation of the orientation of their cylinder axis with the local ortho-radial direction with respect to the optical center of the optical lens smaller than or equal to 5°, for example smaller than or equal to 2°; and/or
the optical element further comprises optical elements positioned radially between two concentric rings; and/or
the mesh structure is a random mesh, for example a Voronoid mesh; and/or
at least part, for example all, of the optical elements have a constant optical power and a discontinuous first derivative between two contiguous optical elements; and/or
at least part, for example all, of the optical elements have a varying optical power and a continuous first derivative between two contiguous optical elements; and/or
the optical elements are configured so that along at least one section of the lens element, for example along at least ten evenly distributed sections, for example a section or sections passing by the optical center of the lens element, the mean sphere of optical elements increases from a point of said section, for example the optical center, towards the peripheral part of said section; and/or
the optical elements are configured so that along at least one section, for example along at least ten evenly distributed sections, of the lens the cylinder power of optical elements increases from a point of said section or sections for example the optical center, towards the peripheral part of said section; and/or
the optical elements are configured so that along the at least one section, for example along at least ten evenly distributed sections, of the lens the mean sphere and/or the cylinder of optical elements increases from the center of said section towards the peripheral part of said section; and/or
the refraction area comprises an optical center and the optical elements are configured so that along at least one, for example at least 50%, for example any, section passing through the optical center of the lens the mean sphere and/or the cylinder power of the optical elements increases from the optical center towards the peripheral part of the lens; and/or
the refraction area comprises a far vision reference point, a near vision reference, and a meridian joining the far and near vision reference points, the optical elements are configured so that in standard wearing conditions along any horizontal section of the lens the mean sphere and/or the cylinder of the optical elements increases from the intersection of said horizontal section with the meridian towards the peripheral part of the lens; and/or
the mean sphere and/or the cylinder power increasing functions along the sections are different depending on the position of said section along the meridian; and/or
the mean sphere and/or the cylinder power increasing functions along the sections are unsymmetrical; and/or
the optical elements are configured so that in standard wearing conditions the at least one section is a horizontal section; and/or
the mean sphere and/or the cylinder power of optical elements increases from a first point of said section towards the peripheral part of said section and decreases from a second point of said section towards the peripheral part of said section, the second point being closer to the peripheral part of said section than the first point; and/or
the mean sphere and/or the cylinder power increasing function along the at least one section is a Gaussian function; and/or
the mean sphere and/or the cylinder power increasing function along the at least one section is a Quadratic function; and/or
the optical elements are configured so that the mean focus of the light rays passing through each optical element is at a same distance to the retina;
and/or
the refractive area is formed as the area other than the areas formed as the plurality of optical elements; and/or
at least one, for example all, of the optical elements is a toric refractive lenslet; and/or
the optical lens is an edged or unedged spectacle lens; and/or

### BRIEF DESCRIPTION OF THE DRAWINGS

Non-limiting embodiments of the disclosure will now be described with reference to the accompanying drawing wherein:

FIG. 1 illustrates a front view of a lens element according to first embodiment of the disclosure;

FIG. 2 illustrates a profile view a lens element according to an embodiment of the disclosure;

FIG. 3 illustrates a front view of a lens element according to a second embodiment of the disclosure;

FIG. 4 illustrates the astigmatism axis γ of a lens in the TABO convention;

FIG. 5 illustrates the cylinder axis γAX in a convention used to characterize an aspherical surface;

Elements in the figures are illustrated for simplicity and clarity and have not necessarily been drawn to scale. For example, the dimensions of some of the elements in the figure may be exaggerated relative to other elements to help to improve the understanding of the embodiments of the present disclosure.

### DETAILED DESCRIPTION OF EMBODIMENTS OF THE DISCLOSURE

The disclosure relates to a lens element intended to be worn by a wearer.

In the reminder of the description, terms like «up», «bottom», «horizontal», «vertical», «above», «below», «front», «rear» or other words indicating relative position may be used. These terms are to be understood in the wearing conditions of the lens element.

In the context of the present disclosure, the term “optical lens” can refer to an uncut optical lens or a spectacle optical lens edged to fit a specific spectacle frame or an ophthalmic lens and an optical device adapted to be positioned on the ophthalmic lens. The “optical lens” in the context of the present disclosure may have a coating such as a hardcoat.

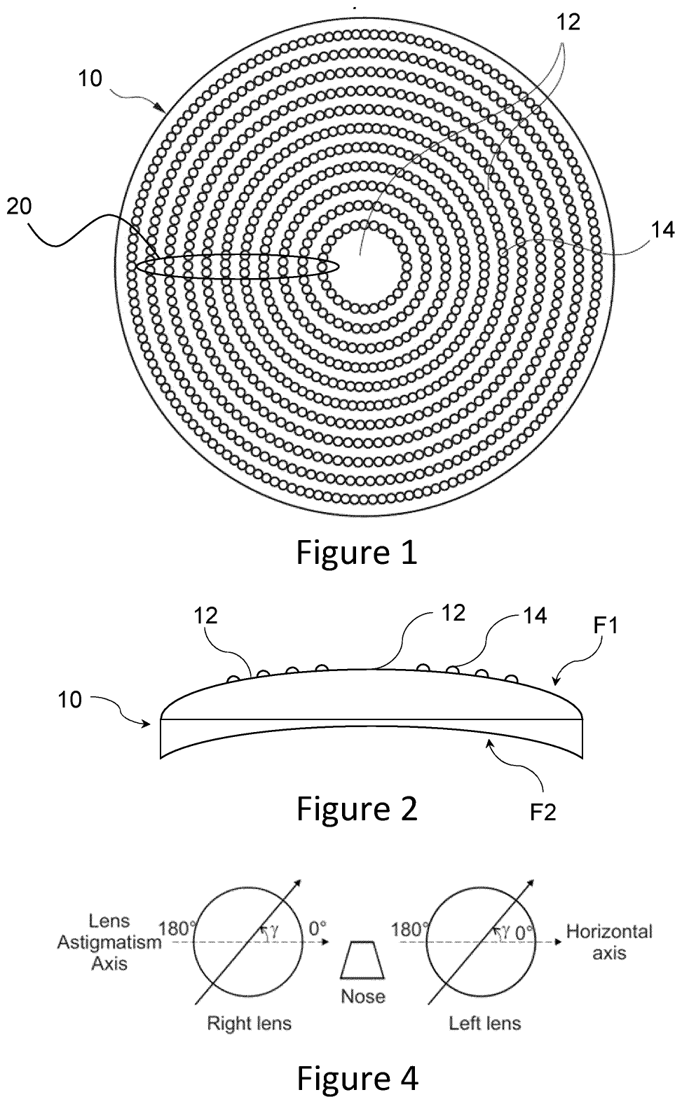

As represented in FIGS. 1 to 3, the optical lens 10 according to the disclosure comprises a refraction area 12 and a plurality of optical elements 14.

As represented in FIG. 2, the optical lens comprises at least a first surface and a second surface opposed to the second surface. For example, the first surface may comprise an object side surface F1 formed as a convex curved surface toward an object side and the second surface may comprise an eye side surface F2 formed as a concave surface having a different curvature than the curvature of the object side surface. The lens element 10 may be made of organic material, thermoset or thermoplastic material, for example polycarbonate, or made of mineral material such as glass.

As illustrated in FIGS. 1 to 3, the lens element 10 comprises a refraction area 12.

The refraction area 12 has a refractive power Px based on the prescription of the eye of the wearer, for example of the person for which the optical lens is adapted. The prescription is for example adapted for correcting an abnormal refraction of the eye of the wearer of the optical lens.

The term “prescription” is to be understood to mean a set of optical characteristics of optical power, of astigmatism, of prismatic deviation, determined by an ophthalmologist or optometrist in order to correct the vision defects of the eye, for example by means of a lens positioned in front of his eye. For example, the prescription for a myopic eye comprises the values of optical power and of astigmatism with an axis for the distance vision.

The prescription may comprise an indication that the eye of the wearer has no defect and that no refractive power is to be provided to the wearer. In such case the refractive area is configured so as to not provide any refractive power.

The refraction area is preferably formed as the area other than the areas formed of the plurality of optical elements. In other words, the refraction area is the complementary area to the areas formed of the plurality of optical elements.

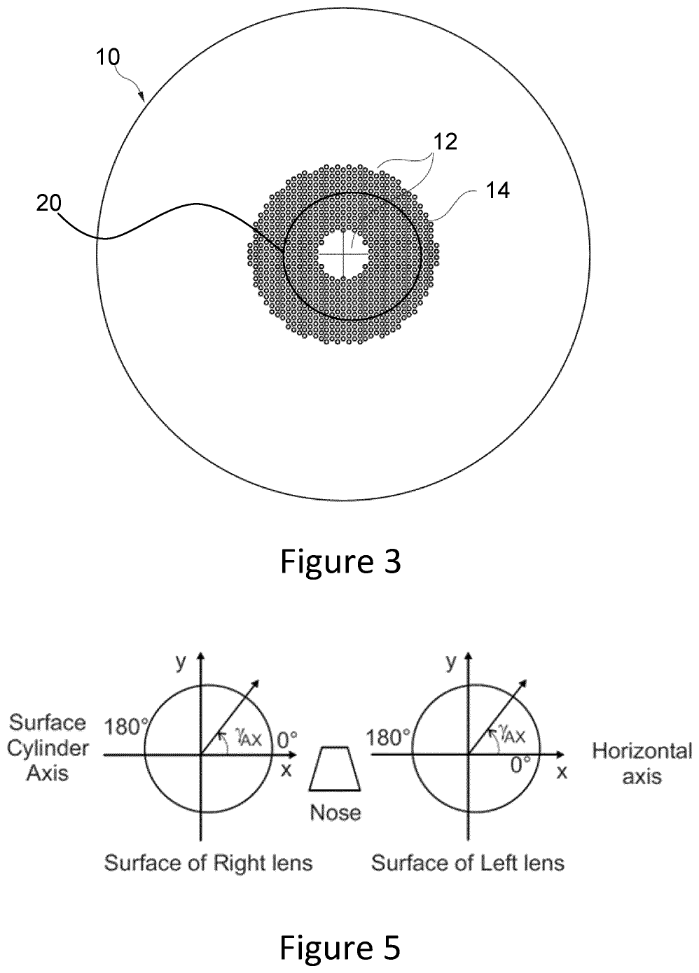

As illustrated in FIGS. 1 and 3, the refraction area 12 may comprise at least the central zone of the optical lens 10.

The central zone may have a characteristic dimension greater than 4 mm and smaller than 22 mm, for example smaller than 20 mm.

For example, the central zone is centered on the optical center of the lens element and has a diameter greater than to equal to 7 mm, for example greater than or equal to 8 mm and smaller than or equal to 15 mm, for example smaller than or equal to 12 mm.

The central zone may be centered on a reference point of the optical lens 10. The reference point on which the central zone may be centered is either one of a geometrical center and/or an optical and/or a near vision reference point and/or a far vision reference point of the optical lens.

Preferably, the central zone is centered on, or at least comprises a framing reference point that faces the pupil of the wearer gazing straight ahead in standard wearing conditions.

The central zone may be free of optical elements as illustrated on FIGS. 1 and 3.

The wearing conditions are to be understood as the position of the optical lens with relation to the eye of a wearer, for example defined by a pantoscopic angle, a Cornea to lens distance, a Pupil-cornea distance, a center of rotation of the eye (CRE) to pupil distance, a CRE to lens distance and a wrap angle.

The Cornea to lens distance is the distance along the visual axis of the eye in the primary position (usually taken to be the horizontal) between the cornea and the back surface of the lens; for example equal to 12 mm.

The Pupil-cornea distance is the distance along the visual axis of the eye between its pupil and cornea; usually equal to 2 mm.

The CRE to pupil distance is the distance along the visual axis of the eye between its center of rotation (CRE) and cornea; for example equal to 11.5 mm.

The CRE to lens distance is the distance along the visual axis of the eye in the primary position (usually taken to be the horizontal) between the CRE of the eye and the back surface of the lens, for example equal to 25.5 mm.

The pantoscopic angle is the angle in the vertical plane, at the intersection between the back surface of the lens and the visual axis of the eye in the primary position (usually taken to be the horizontal), between the normal to the back surface of the lens and the visual axis of the eye in the primary position; for example equal to −8°, preferably equal to 0°.

The wrap angle is the angle in the horizontal plane, at the intersection between the back surface of the lens and the visual axis of the eye in the primary position (usually taken to be the horizontal), between the normal to the back surface of the lens and the visual axis of the eye in the primary position for example equal to 0°.

An example of standard wearing condition may be defined by a pantoscopic angle of −8°, a Cornea to lens distance of 12 mm, a Pupil-cornea distance of 2 mm, a CRE to pupil distance of 11.5 mm, a CRE to lens distance of 25.5 mm and a wrap angle of 0°.

Another example of standard wearing condition more adapted for younger wearers may be defined by a pantoscopic angle of 0°, a Cornea to lens distance of 12 mm, a Pupil-cornea distance of 2 mm, a CRE to pupil distance of 11.5 mm, a CRE to lens distance of 25.5 mm and a wrap angle of 0°.

The central zone may comprise the optical center of the optical lens and have a characteristic dimension greater than 4 mm-corresponding to +/−8° peripheral angle on the retina side, and smaller than 22 mm corresponding to +/−44° peripheral angle on the retina side, for example smaller than 20 mm corresponding to +/−40° peripheral angle on the retina side. The characteristic dimension may be a diameter or the major or minor axes of an ellipse shaped central zone.

The refraction area 12 may further comprise at least a second refractive power Pp different from the prescribed refractive power Px. In the sense of the disclosure, the two refractive powers are considered different when the difference between said refractive powers is greater than or equal to 0.25 D, for example greater than 0.5 D.

When the refractive power Px is prescribed to compensate a myopia of the eye of the wearer, the second refractive power Pp may be greater than the refractive power Px.

When the refractive power Px is prescribed to compensate hyperopia of the eye of the wearer, the second refractive power Pp may be smaller than the refractive power Px.

The refraction area 12 may comprise a continuous variation of refractive power. For example, the refractive area may have a progressive addition design. The optical design of the refraction area may comprise a fitting cross where the optical power is negative, and a first zone extending in the temporal side of the refractive are when the lens element is being worn by a wearer. In the first zone, the optical power increases when moving towards the temporal side, and over the nasal side of the lens, the optical power of the ophthalmic lens is substantially the same as at the fitting cross. Such optical design is disclosed in greater details in WO2016/107919.

Alternatively, the refractive power in the refraction area 12 may comprise at least one discontinuity.

As illustrated in FIGS. 1 to 3, the optical lens 10 comprises a plurality of optical elements 14 and a zone of interest 20 comprising a plurality of said optical elements 14.

At least 50%, for example at least 80%, for example all, of a surface of the optical element 10 may be covered by at least one layer of coating element. The at least one layer of coating element may comprise features selected from the group consisting of anti-scratch, anti-reflection, anti-smudge, anti-dust, UV30 filtration, blue light-filtration, anti-abrasion features.

The layer of coating element may be provided using any known techniques. For example, the layer of coating may be provided using a dipping process where the optical lens simultaneously receives a layer of coating on each surface.

The optical elements have a transparent optical function of not focusing an image on the retina of the eye of the wearer when the optical lens is worn in standard wearing conditions.

In other words, when the wearer wears the lens element, for example in standard wearing conditions, rays of light passing through the plurality of optical elements will not focus on the retina of the eye of the wearer. For example, the optical elements may focus in front and/or behind the retina of the eye of the wearer.

Advantageously, not focusing an image on the retina of the wearer allows creating a control signal that suppresses, reduces, or at least slows down the progression of abnormal refractions, such as myopia or hyperopia, of the eye of the person wearing the lens element.

In the sense of the disclosure, an optical element is considered to have a transparent optical function when said optical element absorbs less than 50%, for example less than 80%, for example less than 95% of the light over the visible spectrum, i.e. 380 nm to 750 nm.

Each optical element 14 within the zone of interest 20 bears a cylindrical component on its surface.

The zone of interest is of a least 50 mm², for example at least 75 mm² and the standard deviation of the orientations of the cylinder axis of each optical element comprised in the zone of interest is smaller than or equal to 15° with respect to a common predefined direction, for example smaller than or equal to 10° with respect to a common predefined direction.

According to an embodiment, the zone of optical interest comprises the optical center of the optical lens and is of at least 150 mm², for example of at least 500 mm². The zone of optical interest may be a circular zone centered on the optical center of the optical lens.

For example, the zone of optical interest is a circular zone centered on the optical center of the optical lens having a radius greater than or equal to 15 mm, for example greater than or equal to 20 mm, for example greater than or equal to 25 mm. The zone of optical interest may be at least 700 mm², for example at least 1250 mm², for example is at least 1900 mm².

Advantageously, having a controlled cylinder orientation of each of the optical elements improves the quality of the vision and the quality of the myopia or hyperopia slow down function of the optical lens.

As illustrated on FIGS. 1 and 3, the zone of interest comprises at least 10 optical elements, for example at least 20 optical elements, for example at least 20 optical elements, for example at least 200 optical elements, for example at least 700 optical elements, having a transparent optical function of not focusing an image on the retina of the eye of the wearer when the lens element is worn in standard wearing conditions.

According to an embodiment, at least 50%, preferably more than 80%, more preferably all the optical elements 14 may be configured, for example in standard wearing conditions, to focus elsewhere than on the retina of the wearer. In other words, the plurality of optical elements may be configured to focus in front and/or behind the retina of the eye of the wearer. The optical function of the optical elements may be defined in standard wearing conditions and considering common eye models, for example an Atchison eye model.

At least 50%, preferably more than 80%, for example all, of the optical elements 14 has a shape configured so as to create a caustic in front of the retina of the eye of the person. In other words, such optical element is configured so that, when the person wears the lens element in standard viewing condition, every section plane where the light flux is concentrated if any, is located in front of the retina of the eye of the person.

At least 50%, for example at least 80%, for example all of the optical elements comprised in the zone of interest have an absolute value of cylinder power greater than or equal to 0.1 D, for example greater than or equal to 0.2 D. The absolute value of the cylinder power being the value of cylinder power of the optical element itself, said value being either positive or negative.

In other words, at least 50%, for example at least 80%, for example all of the optical elements comprised in the zone of interest have an absolute value of cylinder power greater than or equal to −0.1 D, for example greater than or equal to −0.2 D, for example smaller than or equal to −0.5 D and smaller than or equal to 0.1 D, for example smaller than or equal to 0.2 D, for example smaller than or equal to 0.5D.

According to an embodiment of the disclosure, at least 50%, for example at least 80%, for example all, of the optical elements are refractive lenslets, for example aspherical lenslets and at least 50%, for example at least 80%, for example all of the optical elements of the optical lens have an absolute value of cylinder power greater than or equal to 0.1 D, for example greater than or equal to 0.2 D.

The absolute value of the cylinder power being the value of cylinder power of the optical element itself, said value being either positive or negative.

In other words, at least 50%, for example at least 80%, for example all, of the optical elements are refractive lenslets, for example aspherical lenslets and at least 50%, for example at least 80%, for example all of the optical elements of the optical lens have an absolute value of cylinder power greater than or equal to −0.1 D, for example greater than or equal to −0.2 D, for example smaller than or equal to −0.5 D and smaller than or equal to 0.1 D, for example smaller than or equal to 0.2 D, for example smaller than or equal to 0.5D.

As is known, a minimum curvature CURVₘᵢₙ may be defined at any point on an aspherical surface by the formula:

$${CURV}_{min} = \frac{1}{{R}_{max}} ,$$

where Rₘₐₓ is the local maximum radius of curvature, expressed in meters and CURVₘᵢₙ is expressed in diopters.

Similarly, a maximum curvature CURVₘₐₓ can be defined at any point on an aspheric surface by the formula:

$${CURV}_{max} = \frac{1}{{R}_{min}} ,$$

where Rₘᵢₙ is the local minimum radius of curvature, expressed in meters and CURVₘₐₓ is expressed in diopters.

It can be noticed that when the surface is locally spherical, the local minimum radius of curvature Rmin and the local maximum radius of curvature Rmax are the same and, accordingly, the minimum and maximum curvatures CURVmin and CURVmax are also identical. When the surface is aspherical, the local minimum radius of curvature Rmin and the local maximum radius of curvature Rmax are different.

From these expressions of the minimum and maximum curvatures CUR Vmin and CURVmax, the minimum and maximum spheres labeled SPHmin and SPHmax can be deduced according to the kind of surface considered.

When the surface considered is the object side surface (also referred to as the front surface), the expressions are the following:

$${SPH}_{min} = \text{} ( n - 1 ) * {CURV}_{min} = \frac{1 - n}{{R}_{max}} and {SPH}_{max} = ( n - 1 ) * {CURV}_{max} = \frac{n - 1}{{R}_{min}}$$

where n is the refraction index of the constituent material of the lens.

If the surface considered is an eyeball side surface (also referred to as the back surface), the expressions are the following:

$${SPH}_{min} = \text{} ( 1 - n ) * {CURV}_{min} = \frac{1 - n}{{R}_{max}} and {SPH}_{max} = ( 1 - n ) * {CURV}_{max} = \frac{1 - n}{{R}_{min}}$$

where n is the refraction index of the constituent material of the lens.

As is well known, a mean sphere SPHₘₑₐₙ at any point on an aspherical surface can also be defined by the formula:

$${SPH}_{mean} = \frac{1}{2} ( {SPH}_{min} + {SPH}_{max} )$$

The expression of the mean sphere therefore depends on the surface considered:
if the surface is the object side surface,

$$S P {H}_{mean} = \frac{n - 1}{2} ( \frac{1}{{R}_{min}} + \frac{1}{{R}_{max}} )$$

if the surface is an eyeball side surface,

$${SPH}_{mean} = \frac{1 - n}{2} ( \frac{1}{{R}_{min}} + \frac{1}{{R}_{max}} )$$

A cylinder CYL is also defined by the formula CYL=|SPHₘₐₓ−SPHₘᵢₙ|.

The characteristics of any aspherical face of the lens may be expressed by the local mean spheres and cylinders.

For an aspherical surface, a local cylinder axis γ_{AX} may further be defined. FIG. 4 illustrates the astigmatism axis γ as defined in the TABO convention and FIG. 5 illustrates the cylinder axis γ_{AX} in a convention defined to characterize an aspherical surface.

The cylinder axis γ_{AX} is the angle of the orientation of the maximum curvature CURVₘₐₓ with relation to a reference axis and in the chosen sense of rotation. In the above defined convention, the reference axis is horizontal (the angle of this reference axis is) 0° and the sense of rotation is counterclockwise for each eye, when looking at the wearer (0°≤γ_{AX}≤180°). An axis value for the cylinder axis γ_{AX} of +45° therefore represents an axis oriented obliquely, which when looking at the wearer, extends from the quadrant located up on the right to the quadrant located down on the left.

At least part, for example more than 50%, preferably all, of the optical elements 14 may be lenslet having a contour shape being inscribable in a circle having a diameter greater than or equal to 0.2 mm, for example greater than or equal to 0.4 mm, for example greater than or equal to 0.6 mm, for example greater than or equal to 0.8 mm and smaller than or equal to 2.0 mm, for example smaller than or equal to 1.0 mm.

For example, the area of each optical elements is greater than or equal to 0.4 mm² and smaller than or equal to 5 mm², for example smaller than or equal to 4 mm².

The ratio of the total area of the optical elements with respect to the total area of the surface of the optical lens may be greater than or equal 20% and smaller than or equal to 80%.

As illustrated on FIG. 2, at least part, for example all, of the optical elements 14 may be located on the front surface of the optical lens. The front surface of the lens element corresponds to the object side F1 of the lens element facing towards the object.

At least part, for example all, of the optical elements 14 may be located on the back surface of the optical lens. The back surface of the lens element corresponds to the eye side F2 of the lens element facing towards the eye.

At least part, for example all, of the optical elements 14 may be located between the front and the back surfaces of the optical lens, for example when the lens element is encapsulated between two lens substrates. Advantageously, it provides a better protection to the optical elements.

For every circular zone having a radius comprised between 2 and 4 mm comprising a geometrical center located at a distance of the optical center of the optical lens greater or equal to said radius+5 mm, the ratio between the sum of areas of the optical elements 14 located inside said circular zone and the area of said circular zone may be comprised between 20% and 70%.

The optical elements may be randomly distributed on the lens element.

Alternatively and as illustrated in FIG. 1, the optical elements 14 may be organized along a plurality of concentric rings. The concentric rings of optical elements may be annular rings.

Advantageously, such configuration provides a great balance between the slowdown of the abnormal refraction of the eye of the wearer and the visual performances or comfort of the wearer.

The optical lens may comprise optical elements disposed in at least two concentric rings, preferably more than 5, more preferably more than 10 concentric rings. For example, the optical elements may be disposed in 11 concentric rings centered on the optical center of the lens.

The concentric rings of optical elements may have a diameter greater than or equal to 9.0 mm and smaller than or equal to 60 mm.

The distance between two successive concentric rings of optical elements may be greater than or equal to 0.5 mm, for example greater than or equal to 2 mm, the distance between two successive concentric rings being defined by the difference between the outer diameter of a first concentric ring and the inner diameter of a second concentric ring, the second concentric ring being closer to the periphery of the lens element.

According to an embodiment, the optical elements are arranged in concentric ring and at least 60%, for example at least 75%, for example at least 90%, for example all of the optical elements have a radial or ortho-radial orientation of the cylinder axis.

For example, at least 60%, for example at least 75%, for example at least 90%, for example all, of the optical elements have a deviation of the orientation of their cylinder axis with the local radial or ortho-radial direction with respect to the optical center of the optical lens smaller than or equal to 5°, for example smaller than or equal to 2.

The diameter of all optical elements on a concentric ring of the lens element may be identical. For example, all the optical elements on the lens element have an identical diameter.

The zone of interest within which the optical elements have a controlled cylinder may extend radially from the optical center of the optical lens.

As illustrated on FIG. 1, when the optical elements are positioned along at least 5 concentric rings and the zone of interest extends radially over at least 5 of the concentric rings.

Alternatively, at least 50%, for example at least 80%, for example all of the optical elements are positioned on the lens element on a mesh, for example a structured mesh. The structured mesh may be a squared mesh or a hexagonal mesh or a triangle mesh or an octagonal mesh or a honeycomb mesh. Alternatively, the mesh structure may be a random mesh, for example a Voronoï mesh.

FIG. 3 illustrates an embodiment wherein the optical elements are positioned on a honeycomb mesh.

As illustrated on FIG. 3, the zone of interest 20 may comprise the optical center of the optical lens and is of at least 150 mm², for example of a least 200 mm².

Although illustrated on FIG. 3 with a honeycomb mesh, the zone of interest may be of at least 150 mm² with optical elements positioned differently.

The standard deviation of the orientations of the cylinder axis of the at least 50%, for example at least 90%, for example all, of the optical elements may be smaller than or equal to 20° with respect to a common predefined direction, for example smaller than or equal to 15° with respect to a common predefined direction.

At least 20%, for example at least 40% of the optical elements may have a difference of orientation of the cylinder axis with respect to a common predefined direction smaller than or equal to 5°, for example smaller than or equal to 2°.

The disclosure also relates to a method for determining the cylinder orientation of the optical elements of an optical lens according to the disclosure.

Such method first requires measuring the surface of the optical lens. Such surface measurements may be carried out by tactile surface measuring instrument or a non-contact instrument.

One can use a surface profilers, coordinate Measuring Machines, or Non-contact 3D Optical Profilers or any other known surface measuring device.

One can measure a local or global area, depending on the technology used. Some options can be used to measure a larger area such as rectangular or circular stitching. The goal is to measure optical elements over at least the zone of interest.

One can measure the top surface of the optical lens or the surface under the coating layer(s) or even optical elements encapsulated between the front and rear surfaces of the optical lens. For example, the surface of the optical elements may be measured using interferometry. In such case, the index of the coating layer(s) should be known to compensate for the altitude and deduce the true surface from it.

The second step of the method is to remove the shape of the refractive area of the optical lens. The shape of the refractive area should be removed prior to any other metrological operation. This step may be carried out using any known standard solution for analyzing profilometry and topography data.

The shape of the refractive area is usually a revolving shape (cylinder, sphere) corresponding to the prescription of the eye of the wearer. The metrologist is to perform an adjustment or a shape removal before proceeding to the calculation of the surface condition parameters. The operation consists in modeling a shape and associating it with the measured points to then subtract the shape and obtain a flat surface. It may be useful to remove the natural shape by a spherical equation, by a complex polynomial equation, by filtering or by a complex algorithm which uses a Zernike polynomial.

When the base radius is unknown, it may be calculated by the method of the least squares. It is a standard approach in regression analysis to approximate the solution of overdetermined systems by minimizing the sum of the squares of the residuals made in the results of every single equation.

The same approach can be used with a polynomial including power higher than 3. An alternative method is to define a fit surface based on a classic subset of orthogonal Zernike polynomials.

Several statistical parameters can be used as an indicator to determine the best method or best order of approximation: RMS root mean square, average roughness, area flatness deviation.

The third step is to create a clustering with the optical elements to perform the analysis.

At least three methods can be used:
slope filter method, or
height clip method, or
histogram method.

The slope filter method consists in filtering or removing data based on its slope or the angle formed from one pixel to the surrounding pixels.

The height clip method consists in removing data based on a function of height relative to a selected reference.

The histogram method consists in removing data based on a function height relative to a histogram of altitude.

The fourth step is to determine the cylinder of the optical elements using orthogonal Zernike polynomials.

The Zernike polynomial expression is well known of the person skilled in the art. For example, the polynomial expression is defined as follows:

$$Z ( r , \text{} θ ) = \text{} {C}_{0}^{0} + \text{} {\sum }_{n = 1}^{∞} [ \text{} {\sum }_{m = 0}^{n} {C}_{n}^{m} \cdot {N}_{n}^{m} \cdot {R}_{n}^{\vert m \vert} ( r ) \cdot cos ( m θ ) + {\sum }_{m = n}^{- 1} {C}_{n}^{m} \cdot {N}_{n}^{m} \cdot {R}_{n}^{\vert m \vert} ( r ) \cdot sin ( \vert m \vert θ ) ] \qquad ( 1 )$$

Where r is the radial coordinate ranging from 0 to 1, θ is the azimuthal component ranging from 0 to 2n, Cₙ^{m} define the individual polynomial coefficients, Nₙ^{m} is the corresponding normalization factor, and Rₙ^{m}(r) is the radial polynomial defined below. The index n describes the highest power (order) of the radial polynomial, and the index m describes the azimuthal frequency of the sinusoidal component.

The radial functions satisfy the orthogonality relation:

$${\int }_{0}^{1} {R}_{n}^{m} ( r ) \cdot {R}_{{n}^{′}}^{m} ( r ) \cdot r \cdot dr = \frac{1}{2 ( n + 1 )} \cdot {δ}_{{nn}^{′}} \cdot {R}_{n}^{m} \qquad ( 1 )$$

and are normalized so that Rₙ^{m} (1)=1

Orthogonality is fulfilled only in the absence of any “no data” regions within the unit circle. Useful for transforming between polar and Cartesian coordinates system are the following relationships:

$$r = \sqrt{{x}^{2} + {y}^{2}} , θ = {tan}^{- 1} ( y / x ) , x = r cos ( θ ) , and y = r sin ( θ )$$

Alternatively, equation (1) can be expressed in terms of even and odd polynomials:

$$Z ( r , θ ) = {C}_{0}^{0} + {\sum }_{n = 1}^{∞} [ {\sum }_{m = 0}^{n} {C}_{n}^{m} \cdot {Z}_{n}^{m} ( r , θ ) ] + {\sum }_{n = 1}^{∞} \vert {\sum }_{m = 1}^{n} {C}_{n}^{- m} \cdot {Z}_{n}^{- m} ( r , θ ) ]$$

where the even polynomials are given by:

$${Z}_{n}^{m} ( r , θ ) = {N}_{n}^{m} \cdot {R}_{n}^{m} ( r ) \cdot cos ( m θ )$$

and the odd polynomials are given by:

$${Z}_{n}^{- m} ( r , θ ) = {N}_{n}^{m} \cdot {R}_{n}^{m} ( r ) \cdot sin ( m θ )$$

The radial polynomial can be written generally as:

$${R}_{n}^{\vert m \vert} ( r ) = \{ \begin{matrix}{\sum }_{s = 0}^{\frac{n - \vert m \vert}{2}} \frac{{( - 1 )}^{s} ( n - s ) !}{s ! ( \frac{n + \vert m \vert}{2} - s ) ! ( \frac{n - \vert m \vert}{2} - s ) !} {r}^{n - 2 s} ; & for , n - \vert m \vert even \\ 0 ; & for n - \vert m \vert odd\end{matrix} \}$$

While the normalization factor is defined as:

$${N}_{n}^{m} = \{ \begin{matrix}1 ; & for non - normalized PV coefficient \\ \sqrt{\frac{2 ( n + 1 )}{1 + {δ}_{m 0}}} ; & for normalized RMS coefficient\end{matrix} \}$$

where δₘ₀ Kronecker delta function:

$${δ}_{m 0} = \{ \begin{matrix}1 ; & for m = 0 \\ 0 ; & for m \neq 0\end{matrix} \}$$

Under RMS normalization, the polynomials are orthonormal, and the sum in quadrature of the fit coefficient is equal to the energy of the function being fit.

The cylinder power based on Zernike polynomials is a third order wavefront aberration where the rays in two orthogonal axes do not come to focus on the same plane. Zernike polynomials are used to calculate Seidel results, at least 9 Zernike terms must be analyzed to display this result.

The cylinder angle based on Zernike polynomials is the angle in the instrument coordinate system at which astigmatism occurs. The range of values is ±90°. Zernike polynomials are used to calculate Seidel results, at least 9 Zernike terms must be analyzed to display the result.

Cylinder angle=0.5 arctan(Coef_{2,-2}/Coef_{2,2})

The transformation of Zernike or Seidel results from μm to diopter is known of the skilled person and for example is disclosed in volume 5, page 110 of “Encyclopedia of Modern Optics” Second Edition published by Elsevier Ltd. In 2018.

Measuring the lenslets over the whole surface of the optical lens may be complex with the current available measuring device. The disclosure further relates to a method for measuring the whole surface of the optical lens using a currently available interferometry device.

The interferometry device is able to measure the shape, waveness, roughness of the surface of the optical lens and in particular of the optical elements, by a technique which uses the interference of superimposed waves to extract information of altitude (x, y, z data).

Combined with a X, Y motorized stage and stitching process, one can extend the measure, larger than the field of the initial objective.

Due to the limitation of slop according to the objective, one can only measure a part of the optical element extending radially from center to peripheral of the optical lens. This allows measuring over a zone of interest that extends radially from the optical center of the optical lens.

However, one cannot measure over a circle, for example a ring of lenslets as illustrated on FIG. 1.

With a rotative stage adapted on the measuring device, one can measure each lenslet according to the rotation position. With an elementary mathematical process, one can compute the real x,y position of each picture and stitch the final result to get measurements over a full ring of lenslets.

Most measuring device use the x,y position of each frame to compute the final stitching because the accuracy is better than using the common data of each frame. At the end, one can measure all the structure of optical elements, for example the 11 rings of optical elements represented on FIG. 1.

This method is also available for measuring optical elements that are encapsulated, i.e. comprised between the front and back surfaces of the optical lens, or under a coating.

The disclosure has been described above with the aid of embodiments without limitation of the general inventive concept. Many further modifications and variations will be apparent to those skilled in the art upon making reference to the foregoing illustrative embodiments, which are given by way of example only and which are not intended to limit the scope of the disclosure, that being determined solely by the appended claims.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used. Any reference signs in the claims should not be construed as limiting the scope of the disclosure.

1. An optical lens intended to be worn by a wearer comprising:
a refraction area having a refractive power based on a prescription for eye of the wearer;
a plurality of optical elements having a transparent optical function of not focusing on a retina of the eye of the wearer when the optical lens is worn in standard wearing conditions,
a zone of interest including a subset of the optical elements, each optical element in the subset bearing a cylinder component on a surface of the optical element,
wherein the zone of interest includes an optical center of the optical lens and is of at least 500 mm², and
a standard deviation of orientations of cylinder axis of each optical element included in the zone of interest is smaller than or equal to 15° with respect to a common predefined direction.

2. The optical lens according to claim 1, wherein the zone of interest includes at least ten optical elements having a transparent optical function of not focusing on the retina of the eye of the wearer when the lens is worn in standard wearing conditions.

3. The optical lens according to claim 1, wherein at least 50% of the optical elements have an optical function which does not focus on the retina of the eye of a person when the optical lens is worn in standard wearing conditions.

4. The optical lens according to claim 1, wherein at least 50% of the optical elements have an absolute value of cylinder power greater than or equal to 0.1 D.

5. The optical lens according to claim 1, wherein at least part of one of a front or back surface of the optical lens includes at least one layer of at least one coating element covering at least part of the surfaces on which the optical elements are placed.

6. The optical lens according to claim 1, wherein at least 50% of the optical elements are located on one of the surface of the optical lens.

7. The optical lens according to claim 1, wherein at least 50% of the optical elements are located between front and back surfaces of the optical lens.

8. The optical lens according to claim 1, wherein at least 50% of the optical elements are refractive lenslets.

9. The optical lens according to claim 1, wherein the zone of interest extends radially from the optical center of the optical lens.

10. The optical lens according to claim 1, wherein at least 50%, of the optical elements are positioned along at least 5 five concentric rings and wherein the zone of interest extends radially over at least 5 five of the concentric rings.

11. The optical lens according to claim 1, wherein at least 50% of the optical elements are positioned on a structured mesh, the structured mesh being a squared mesh or a honeycomb mesh or a triangle mesh or an octagonal mesh.

12. The optical lens according to claim 1, wherein the zone of optical interest includes the optical center of the optical lens and is of at least 1000 mm².

13. The optical lens according to claim 1, wherein the standard deviation of the orientations of the cylinder axis of the at least 50% of the optical elements is smaller than or equal to 20° with respect to a common predefined direction.

14. The optical lens according to claim 1, wherein at least 20% of the optical elements have a difference of orientation of the cylinder axis with respect to a common predefined direction smaller than or equal to 5°.

15. The optical lens according to claim 1, wherein a ratio of a total area of the optical elements with respect to the total area of the surface of the optical lens is greater than or equal 20% and smaller than or equal to 80%.

16. The optical lens according to claim 2, wherein at least 50% of the optical elements have an optical function which does not focus on the retina of the eye of a person when the optical lens is worn in standard wearing conditions.
